(19) United States
(12) Patent Application Publication
(10) Pub. No.: US 2022/0375301 A1
(43) Pub. Date: Nov. 24, 2022

(54) METHODS AND DEVICES FOR COMPARING OBJECTS

(71) Applicant: SENSETIME INTERNATIONAL PTE. LTD., Singapore (SG)

(72) Inventors: SHUO ZHUANG, Singapore (SG); XINXIN WANG, Singapore (SG)

(21) Appl. No.: 17/363,654

(22) Filed: Jun. 30, 2021

Related U.S. Application Data
(63) Continuation of application No. PCT/IB2021/055657, filed on Jun. 25, 2021.

(30) Foreign Application Priority Data
May 19, 2021 (SG) 10202105278V

(51) Int. Cl. G07F 17/32; G06K 9/00; G06T 7/70

(52) U.S. Cl. CPC G07F 17/3241; G06K 9/00771; G06T 7/70; G06T 2207/30232

(57) ABSTRACT

A method and device of comparing objects are provided in the embodiments of the present disclosure, wherein the method may comprise: acquiring first object information and second object information, wherein the first object information is acquired by detecting a first object involved in a first image, and the second object information is acquired by detecting a second object involved in a second image; the second object is used to exchange for the first object; the object comparison result is determined based on the first object information and the second object information; the object comparison result indicates whether the first object and the second object are equivalent in value. The embodiments of the present disclosure improve the efficiency and accuracy of object exchange.

### CROSS REFERENCE TO RELATED APPLICATION

This application is a continuation of International Application No. PCT/IB2021/055657 filed on Jun. 25, 2021, which claims priority to Singaporean Patent Application No. 10202105278V entitled “METHODS AND DEVICES FOR COMPARING OBJECTS” and filed on May 19, 2021, all of which are incorporated herein by reference in its entirety.

### TECHNICAL FIELD

The embodiments of the present disclosure relate to image processing technology, and in particular to methods and devices for comparing objects.

### BACKGROUND

With the continuous development of technology, more and more scenarios are expected to be more intelligent. For example, in a game, it is desirable to automatically monitor what's happening. Assuming there is a game stage in which a player exchanges one type of game items for another type of game items, such as exchanging five game items A for three game items B, whether the five game items A are equivalent to the three game items B can be verified via manually counting by the game master. In this way, if the game master is not focused or makes mistakes in operation, errors may occur.

### SUMMARY

In view of this, the embodiments of the present disclosure provide at least one method and device of comparing objects to improve the accuracy of object counting.

In a first aspect, according to an aspect of the embodiments of the present disclosure, a method of comparing objects is provided, which comprises:

acquiring first object information and second object information, wherein, the first object information is acquired by detecting a first object involved in a first image, and the second object information is acquired by detecting a second object involved in a second image. The second object is to be exchanged for the first object;

determining an object comparison result according to the first object information and the second object information, wherein the object comparison result indicates whether the first object and the second object are equivalent in value.

In a second aspect, examples of the present disclosure provide an apparatus of comparing objects, which comprises:

an information acquisition module, which is configured to acquire first object information and second object information. Wherein, the first object information is acquired by detecting a first object involved in a first image, and the second object information is acquired by detecting a second object involved in a second image. The second object is to be exchanged for the first object;

a comparison processing module, which is configured to determine an object comparison result according to the first object information and the second object information, wherein the object comparison result indicates whether the first object and the second object are equivalent in value.

In a third aspect, an electronic device, a memory, and a processor are provided. The memory is used to store computer-readable instructions, and the processor is used to call the computer instructions to implement the object comparison method described in any one embodiment of the present disclosure.

In a fourth aspect, a machine-readable storage medium storing programmable device codes is provided, where the codes are executed by a controller to implement the object comparison method described in any one embodiment of the present disclosure.

In a fifth aspect, a computer-readable storage medium having a computer program stored thereon is provided, where when the computer program is executed by a processor, the method of comparing objects described in any one embodiment of the present disclosure is implemented.

By the method and device for comparing objects provided according to the embodiments of the present disclosure, first object information and second object information can be acquired through image detection and used to determine the result of object comparison. As the acquired object information is more objective and accurate, and will not be affected by human subjective factors, an exchange performed accordingly can be more accurate. In addition, the object information is acquired and compared automatically, which is more efficient than manual verification.

### BRIEF DESCRIPTION OF THE DRAWINGS

In order to more clearly describe the technical solutions in one or more embodiments of the present disclosure or related technologies, a brief description of the appended drawings involved in the embodiments or related technical descriptions is provided below. Obviously, the drawings in the following description are only concerned with one or more embodiments recorded in this present disclosure. For those of ordinary skill in the art, other drawings can be acquired according to these drawings without any creative labor.

FIG. 1 is a flowchart of a method of comparing objects according to at least one embodiment of the present disclosure;

FIG. 2 is a flowchart of a method of comparing objects according to at least one embodiment of the present disclosure;

FIG. 3 is a first schematic diagram of a game on a game table provided by at least one embodiment of the present disclosure;

FIG. 4 is a flowchart of a method of comparing objects according to at least one embodiment of the present disclosure;

FIG. 5 is a schematic structural diagram of an object state detection according to at least one embodiment of the present disclosure;

FIG. 6 is a schematic structural diagram of a game place system according to at least one embodiment of the present disclosure;

FIG. 7 is a flowchart of monitoring progress of counting game coins by a game master according to at least one embodiment of the present disclosure;

FIG. 8 is a schematic structural diagram of an apparatus of comparing objects according to at least one embodiment of the present disclosure;

FIG. 9 is a schematic structural diagram of an apparatus of comparing objects according to at least one embodiment of the present disclosure.

### DETAILED DESCRIPTION OF THE EMBODIMENTS

To make a person skilled in the art better understand technical solutions provided by one or more embodiments of the present disclosure, the technical solutions in one or more embodiments of the present disclosure will be clearly and completely described below with reference to the accompanying drawings in one or more embodiments of the present disclosure.

Apparently, the embodiments described are merely some embodiments of the present disclosure, but not all embodiments. Based on one or more embodiments of the present disclosure, all other embodiments acquired without creative work by those of ordinary skill in the art should fall within the protection scope of the present disclosure.

In a gaming place, sometimes there is such a game stage where a player exchanges one type of game items for another. For example, a player can exchange five game items A for six game items B, and in a next stage, the exchanged game items B are used to play games with other players.

The exchange of such game items usually is expected to be equivalent. For example, the game item A can be preset in the game with multiple sub-types, and different sub-types of game items A can be exchanged for different numbers of game items B. Exemplarily, assuming that game item A includes three sub-types: a1, a2, and a3, where each game item A of sub-type a1 can be exchanged for one game item B, each game item A of sub-type a2 can be exchanged for two game items B, and each game item A of sub-type a3 can be exchanged for three game items B. In the foregoing example, four of the five game items A could be of sub-type a1 and one of sub-type a2, which can be exchanged six game items B in total. Of course, the above is only an example, and more complicated exchange rules can be set in real games. For example, the game item B may also include multiple sub-types with set equivalent exchange rules with different sub-types of game item A.

Regardless of the specific exchange rules, an exchange of game items is involved. Traditionally, the game master can manually check whether an exchange of different game items is equivalent. For example, to verify whether exchanged game items B are equivalent to game items A. Exemplarily, in the above example, if five game items A are exchanged for four game items B, then an error has occurred in this exchange, and it is expected to be corrected to be exchanged for six game items B. Therefore, this exchange scenario is expected to monitor whether the exchange is correct.

The embodiments of the present disclosure provide a method of comparing objects, which aims to avoid possible errors caused by manual verification as far as possible, to realize automatic monitoring of exchange results, and to improve the efficiency and accuracy of monitoring. Understandably, this method can be applied to any one of similar exchange scenarios, and is not limited to a game exchange.

FIG. 1 is a flowchart of a method of comparing objects according to at least one embodiment of the present disclosure. As shown in FIG. 1, the method includes the following steps.

In step 100, acquiring first object information and second object information;

wherein, both the first object information and the second object information are acquired through image detecting.

For example, a first image can involve a first object, and first object information is acquired by detecting the first object. Exemplarily, the first image may be an image captured by a camera installed above a game table. The image may involve a pile of game coins A placed on a game table, and the game coins A may be referred to as a first object. Optionally, the first image may be input to a pre-trained neural network to obtain the first object information, which is the information of the game coins A detected and output by the neural network. For example, the first object information may include but is not limited to a number of game coins A, the denomination of each game coin A, etc.

Similarly, a second image may involve a second object, and second object information is acquired by detecting the second object. For example, a second image can be captured by a camera installed above a game table. The second image may involve a pile of game coins B placed on the game table. And the second object information such as a number and denomination of the game coins B can be detected and output by the neural network. Wherein, a game player can exchange the game coins A for the game coins B in a game stage, and in the next stage, the game player can use the game coins B to continue playing the game.

In addition, a first image and a second image may be a same image or different images.

In step 102, determining an object comparison result according to the first object information and the second object information, wherein, the object comparison result indicates whether the first object and the second object are equivalent in value.

In an example, it can be determined whether the first object and the second object are equivalent in value according to the first and second object information acquired. Exemplarily, following methods can be used to determine whether the exchange is equivalent. Determining a first object value according to a first object attribute and a first object quantity related to the first object. Determining a second object value according to a second object attribute and a second object quantity related to the second object. Then judging whether the first object value and the second object value are equal. If they are equal, it is an equivalent exchange.

For example, taking a pile of game coins A and a pile of game coins B as two objects expected to be compared with each other. Each object attribute includes the denomination of the game coins. For example, suppose that a first object includes the pile of game coins A and a second object includes the pile of game coins B, and the following information is acquired by detecting, including: the quantity of game coins A (for example, 5), the denomination of each game coin A (for example, all game coins A are from a1, a sub-type of A, whose denomination is ten), the number of game coins B (for example, 6) and the denomination of each game coin B (for example, two from b1 and four from b2, where in b1 and b2 are two different sub-types of B, denominations of b1 and b2 are five and ten separately). Then, during the comparing, it can be calculated that the value of the pile of game coins A is 5*10=50, and the value of the pile of game coins B is 5*2+4*10=50. Therefore, the pile of game coins A and the pile of game coins B are equivalent in value.

The object comparison result can indicate whether a first object and a second object are equivalent in value. For example, the object comparison result can include two values “11” and “00”, where “11” can indicate an equivalent exchange and “00” can be used to indicate a non-equivalent exchange. Then, in the above example, if it is determined that the pile of game coins A and the pile of game coins B are equivalent in value, the result of the object comparison can be acquired as “11”.

In another embodiment, after determining an object comparison result, the exchange alert message may be output if the object comparison result indicates that the first object and the second object are non-equivalent in value. For example, in the above example, if the result of the object comparison is “00”, it means that the value of the pile of game coins B exchanged is not equal to the value of the pile of game coins A, and the exchange alert message can be output.

In actual implementation, a game control terminal can be placed on a game table. The game control terminal can be a device used by the game master to control the game progress. The exchange alert message can be output to the display screen of the game control terminal to prompt the game master accordingly after determining a non-equivalent exchange. For example, a player may exchange a pile of his game coins A for a pile of game coins B from a game master. If the game control terminal prompts the manager to make a mistake in exchange, the manager can verify and correct the number of exchanged game coins B. Exemplarily, if it is correct to exchange for 6 game coins B, but the game master is not concentrated and only gives the player 5 game coins B, and then the game control terminal will give an alarm prompt to the master.

In order to speed up the efficiency, the exchange alert message can be more in detail, not only can indicate the exchange error, but also can carry object deviation information to prompt how to correct it accordingly. For example, in the above example, the correct one should be exchanged for 6 game coins B, but in reality, only 5 game coins B are exchanged for the player. The object information deviation is “one less game coin B”, and the output exchange alert message can prompt “Exchange error, one less game coin B”, so that the master can correct the exchange error more quickly, without manually calculate the deviation.

By the method of comparing objects in this embodiment, first object information and second object information can be acquired through image detection, and used to determine the result of object comparison. As the acquired object information is more objective and accurate, and will not be affected by human subjective factors, an exchange performed accordingly can be more accurate. In addition, the object information is acquired and compared automatically, which is more efficient than manual verification.

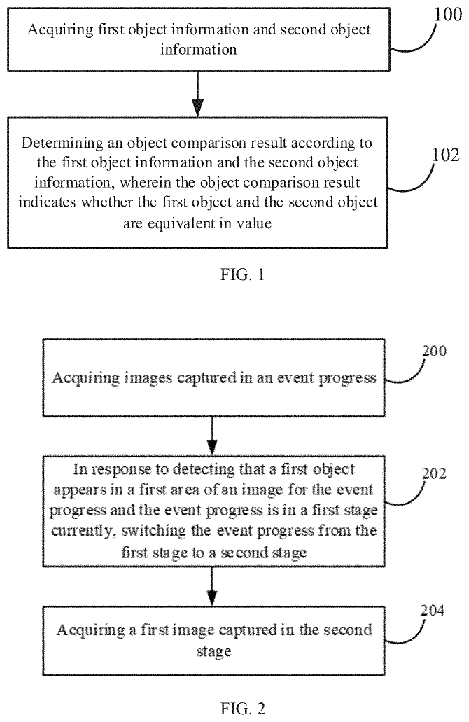

FIG. 2 shows a method of comparing objects provided by at least one embodiment of the present disclosure. An exchange of objects can occur in a stage of an event, for example, during one game stage of an entire game. This embodiment will describe how to monitor the progress of an event, and to acquire first object information involved in a first image and second object information involved in a second image at an appropriate event stage.

In this embodiment, a game is taken as an example for an event. The game may include multiple game stages, and one rule of the game is one of game stages is for the exchange of game items. In addition, in this game, it is also assumed that cameras are arranged around the game table to continuously capture game table images, so as to detect and learn the progress of the game on the game table through the game table images.

As shown in FIG. 2, the method includes operations 200, 202 and 204.

In step 200, acquiring images captured in an event progress.

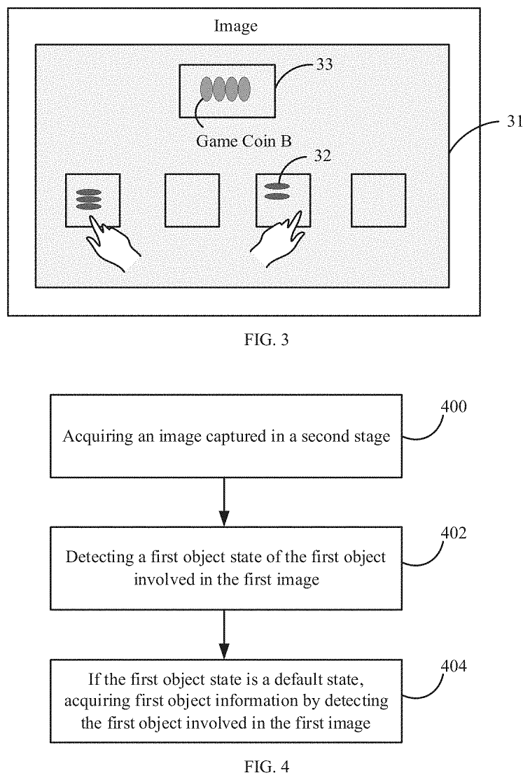

For example, if multiple players are participating in a game at a game table, a camera above the game table can capture images of what's happening on the game table. For example, please refer to the schematic diagram of FIG. 3. In the image, there is a game table 31 on which there is a pile of game coins 32. Multiple players participate in the game at this game table.

In step 202, in response to detecting that a first object appears in a first area of an image for the event progress and the event progress is in a first stage currently, switching the event progress from the first stage to a second stage;

In this step, an event in this embodiment takes a game as an example, and the event progress may be the game progress. Exemplarily, target detection of images on a game table can be carried out by the pre-trained neural network, so as to learn the progress of the game. For example, assuming that the game may include stages 1, 2, 3 and so on, and the current game progress will be recorded in the cache, for example, the current game is in the stage 1. The detection of the game progress can be reflected by changes of object states. For example, as shown in FIG. 3, suppose that it is detected that a pile of game coins B (referred to as a first object) appears in a first area 33 of the image. Specifically, the state of the pile of game coins B from non-present to present is acquired by monitoring multiple images. For example, the pile of game coins B is not detected in the first area 33 of the image P1, while they are detected in the first area 33 of the image P2 that captured in the later time sequence. Then it can be considered that the pile of game coins B is placed in the first area 33 recently. In combination, the game progress recorded in the cache is in the stage 1 currently, and it can be determined that the game process should be switched to the stage 2.

It should be noted that the above stage switching conditions are only examples, and the conditions for event progress switching can be defined according to business requirements in actual implementation. For example, when the game progress is switched from the stage 1 to the stage 2, it is required not only to detect the presence of the first object in the specific area, that is “the first area”, of the image, but also to detect a body part an operator uses to manipulate the first object in the image. For example, the detection of a player's hand in the image indicates that the player has placed the first object in the first area, and it is only then that the game progresses should be switched from the stage 1 to the stage 2. It can also be set as other stage switching conditions, which will not be in detail here.

In step 204, acquiring a first image captured in the second stage.

When it is determined that the game progress is switched from the stage 1 to the stage 2, game table images captured during stage 2 of the game can be acquired. Wherein, the number of game table images collected in stage 2 of the game may be one or more, from which a first image can be determined, and first object information can be acquired by detecting the first object in the first image,

In addition, a second image may be captured in other game stages. For example, it may be an image captured in the stage 1 or other stages of the game, and the image is used to be detected to acquire second object information involved in the image. Similarly, the second image can also be acquired in a similar manner to the above, when it is monitored that game progress has entered a certain predetermined game stage.

The way to obtain the first image in the second stage includes but is not limited to the following examples.

For example, if a game master places all the game coins B to be exchanged to a player in the first area 33 of the game table at one time, then it is determined as a first image that the image captured where the game coins B are placed in the first area 33 of the game table. And first object information can be acquired by target detection of the first image.

For another example, a game master can also place the game coins B to be exchanged for a player in the first area 33 of the game table multiple times. For example, a total of 6 game coins B is expected to be exchanged for the player. The first time, he takes 4 game coins B to the first area 33, and then take 2 more to the first area 33 for the second time. In this case, in an image set including multiple images captured in the stage 2 of the game, it is possible that multiple images may involve game coins B, and the number of coins B in different images is different. For each of the images in the image set, detecting a number of coins B and determining an image for which the number of coins B is largest as the first image. The image with the largest number of game coins B is the one after placing all the game coins B at the end of multiple times.

In addition, still taking an event is a game as an example, the game process may also include other stages other than the stage 1 and stage 2 mentioned above. For example, the game may also include a stage 3, which may be a stage prior to the stage 1. Specifically, if it is detected that a second object is placed in a second area of a game table in an image captured by a camera, the second object may be an item for exchanging game coins, and if it is detected the current game progress is in the stage 3, in this case, the game progress can be triggered to switch from the stage 3 to the above-mentioned stage 1. Moreover, a second image involving the second object may be acquired in the stage 1.

That is, in this example, the game flow can be switched in sequence according to the stage 3, the stage 1, and the stage 2. A second image is acquired in the stage 1, and a first image is acquired in the stage 2. Then by detecting the images captured, acquiring object information, such as first object information or second object information. In actual implementation, other game stages may also be included. The method of comparing objects in this embodiment may be applied in some of the stages of the event all stages.

In other examples, the timing of related business processing can also be determined based on the monitoring of an event stage.

For example, still taking the switching of the game progress as an example, assuming that the current game progress (that is, the event progress of the game) is in the stage 2. If it is detected that the second object is disappeared from the second area of the game table in the mage, it can be canceled that an exchange alert message that prompts the first object and the second object are non-equivalent in value. In this example, the game progress may enter a final stage after the stage 2. In this final stage, the exchange alert message output previously can be canceled. The cancellation here means that the alert will no longer continue. For example, when it is originally detected that the first object and the second object are not equivalent in value, a prompt message such as “Exchange error, one less game coin B” can be output on the display screen of the game control terminal. The above-mentioned cancellation means that cancel the display of the prompt message on the screen.

For another example, in response to detecting that the second object is disappeared from a second area in an image of the game table and the game progress is in the stage 2 currently, it may be determined to enter the final stage of the game according to the disappearance of the second object. It can be started that the process of clearing event cache information, clear the information temporarily stored during this game, free and set up a space for storing game information for a next game. For example, the event cache information described above can include at least one of the event processes, object information, and object values. For example, the event process can be a record of stages of game progress during a game; the object information may be first object information or second object information; the object values can be a first object value based on attributes and number of a first object, or a second object value based on attributes and number of a second object.

In response to detecting that the second object is disappeared from a second area in an image of the game table and the game progress is in the stage 2 currently, at least one of the above-mentioned cancellation of exchange alert message and clearing of event cache information can be performed.

By the method of comparing objects in this embodiment, first object information and second object information can be acquired through image detection, and used to determine the result of object comparison. As the acquired object information is more objective and accurate, and will not be affected by human subjective factors, an exchange performed accordingly can be more accurate. In addition, the object information is acquired and compared automatically, which is more efficient than manual verification. In addition, the way by acquiring the object information in an image captured in a specific event stage may not be expected to process all the images in the entire process of the event. Alternatively, selecting and processing some of the images to save processing resources. Besides, monitoring an exchange in a specific event stage can also more accurately control the timing of the exchange operation, and more accurately capture the images for exchange monitoring.

FIG. 4 shows another method of comparing objects provided by at least one embodiment of the present disclosure. In this embodiment, during the acquisition of a first image, even if the image involves all game coins B to be exchanged for a player, it cannot be determined as the first image accordingly. It is also to detect the state of the game coins B in the image, and only when the predetermined object state is satisfied, can it be confirmed as the first image to acquire the corresponding first object information. As shown in FIG. 4, the process includes operations 400-406.

In step 400, acquiring an image captured in a second stage.

For example, an image captured in the stage 2 of the game may be acquired, and the image may involve a game table and a pile of game coins B placed on the game table. The pile of game coins B is to be exchanged to a player.

In step 402, detecting a first object state of the first object involved in the first image.

In this example, a first object state can include a variety of object states. For example, it can include “spread” and “stacked” states. When the first object state is in the “spread” state, a pile of game coins B, as the first object, can be spread out on the game table; when the first object state is in the “stacked” state, a pile of game coins B, as the first object, can be stacked into a stack and placed on the game table.

In an embodiment, the object state of the pile of game coins B can be detected by the following steps.

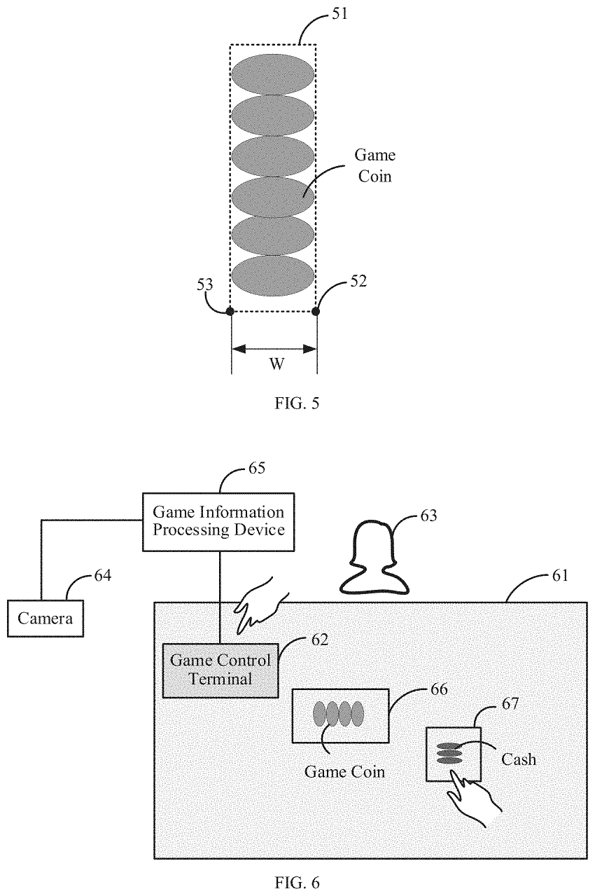

Acquiring an object box about the pile of game coins B through a neural network to detect the pile of game coins B involved in the first image. For a clearer and more convenient description, please refer to the schematic diagram in FIG. 5. FIG. 5 illustrates an object box 51 detected from an image. The object box 51 may include several key points, including key points 52 and key points 53. The value of the distance W shown in FIG. 5 can be determined according to the coordinates of the key point 52 and the key point 53. The W can be the width of one game coin, and can be referred to as a physical space parameter of the game coin, which represents the radial length value of the game coin in a certain direction.

For example, W can be 2.1 cm. Assume that the preset parameter threshold range is from 1.9 to 2.3 cm. If W is in the range, it is determined that a pile of game coins B is in the “stacked” state. And if the value of W is 9 cm, which exceeds the parameter threshold range, it can be considered that the pile of game coins is in a “spread” state.

In addition, it should be noted that the determination of the above parameter W is only an example. In a specific implementation, it is possible to determine which parameters can be used to judge the object state according to the characteristics of different object states, such as being stacked or spread.

In step 404, if the first object state is a default state, acquiring first object information by detecting the first object involved in the first image.

For example, the default state can be “stacked” state. If a pile of game coins B is stacked, the corresponding first object information can be acquired. For example, the number and denomination of the plie of game coins B can be acquired to calculate its value.

In actual implementation, for example, in a game coins exchange scenario, the number and denomination of a pile of game coins A and a pile of game coins B should be acquired in order to correctly judge whether the exchange is equivalent. The calculation of the number of game coins based on the image detection is more accurate when the game coins are in the stacked state. If the game coins are in the spread state, there is a greater risk to compute a wrong result. Therefore, a game master can in advance place a pile of game coins B in a stacked state when taking them on a game table, so as to facilitate the camera to capture a suitable image to compute the number of the pile of game coins B more accurately. Then, an image whose object state is a preset state can be found according to the above-mentioned object state detection method. By detecting the image, the object information can be acquired to be used as the basis for subsequent exchange comparisons. In this way, the influencing parameters used to calculate object value can be acquired more accurately as much as possible, so that the exchange monitoring can also be more accurate.

By the method of comparing objects in this embodiment, first object information and second object information can be acquired through image detection, and used to determine the result of object comparison. As the acquired object information is more objective and accurate. In addition, the object information is acquired and compared automatically, which is more efficient than manual verification. What's more, by acquiring the image of the object state in a preset state, the influencing parameters used to compute object value can be acquired more accurately, so that the comparison result between the first object information and the second object information is also more accurate.

Take the application of the method of comparing objects in a game place as an example. Like, when playing a baccarat game in the game place, a player is expected to exchange cash for game coins from a game master to use the game coins to play the baccarat game. The game master is responsible for determining the number of game coins to be exchanged based on the player's cash. The following example will describe how to apply the method of comparing objects in this disclosure to monitor whether the number of game coins offered by the game master is correct and whether it is equivalent to the player's cash.

FIG. 6 shows a schematic diagram of a game place system provided by at least one embodiment of the present disclosure. As shown in FIG. 6, it illustrates one of game tables in the game place. A game control terminal GTT (Graphical Table Terminal) is arranged on the game table 61. The GTT 62 is a device used by the game master 63 to control the game progress, and it may include a display screen for displaying information during the game. For example, the game master 63 can switch game progress through the GTT 62. A camera 64 is also installed above each table 61 to capture images of the game table. For example, a bird's-eye view camera and a side-view camera can be installed to collect game table images from different shooting angles. In FIG. 6, only one camera is used.

The GTT 62 and the camera 64 can be connected to a game information processing device 65. The game information processing device can be deployed under or around the game table, receive the game table image captured by the camera 64, and monitor the game process at the game table based on information acquired from image detection. For example, when playing a baccarat game on the game table, according to the collected images, the game information processing device 65 can automatically monitor whether the game master's order of issuing cards is correct and whether the number of game coins exchanged for a player is correct and so on. The method of comparing objects in the embodiment of the present disclosure can be executed on the game information processing device 65. If the result of the object comparison indicates that a player's cash and exchanged game coins do not match, the exchange alert message can be sent to the GTT 62 to remind the game master 63 to correct it as soon as possible.

Please continue to refer to FIG. 6. The game table also includes a first area 66 and a second area 67. A player can place cash in the second area 67 during the game stage of exchanging game coins, and the game master 63 will place the corresponding equivalent game coins in the first area 66 and hand them over to the player. The method of comparing objects in the embodiment of the present disclosure will be used to monitor whether the number of game coins taken by the game master to be exchanged to the player 63 is correct and the value of the game coins is equivalent to the cash given by the player. It should be noted that the game table may include multiple hot spots, including but not limited to the above-mentioned the first area 66 and the second area 67. Different hot spots may correspond to different functions in a game. For example, the game may limit the player bet in a certain hot spot, or limit the game master to place game coins in a certain hot spot.

In addition, the baccarat game in this example can be divided into different states, that is different game progressions, including idle (standby phase, the state in which game information processing device is turned on), betting (player betting phase), gaming (game master deal phase), payout (game result phase), halt (error pause phase) and so on. The method of comparing objects in embodiment of the present disclosure can be applied to the betting state mentioned above, specifically, it is applied to the “cash buy in” phase in the betting state. There are four stages in the “cash buy in” phase:

Player Putting Cash: A player puts cash, that is, the player puts the cash to be exchanged for game coins on a table.

Game Master Putting Cash: A game master counts the cash, that is, to confirm how much cash the player puts.

Game Master Putting Game Coins: The game master counts the game coins, that is, the game master puts out the game coins to be given to the player.

Game Master Collection Cash: The game master collects the cash and the player completes the game coins exchange.

More specifically, the comparison between the object information carried out by the method of comparing objects in the embodiment of the present disclosure is mainly used to monitor whether the game coins offered by the game master and the cash offered by the player are equivalent in value. If they are not equivalent in value, GTT can inform the game master.

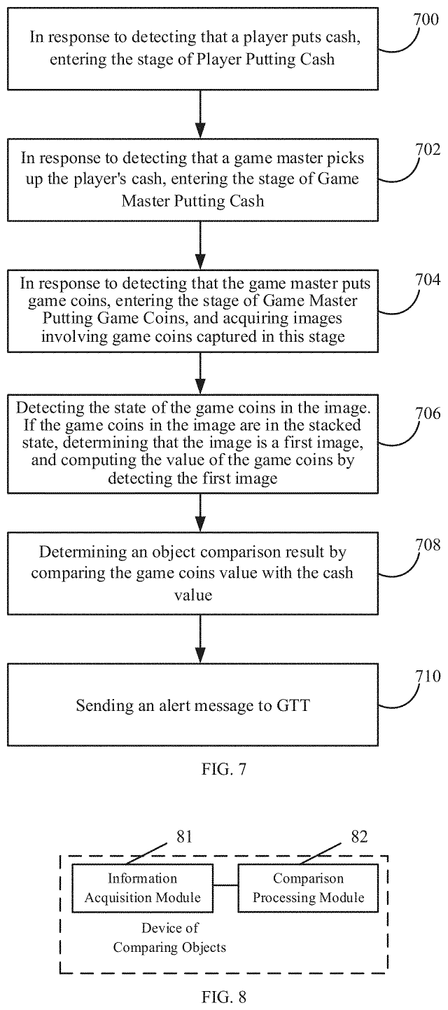

FIG. 7 illustrates a monitoring process of Game Master Putting Cash, including the following steps. These steps all processed during the “cash buy in” phase, involving the monitoring of the entire “cash buy in” phase.

In step 700, in response to detecting that a player puts cash, entering the stage of Player Putting Cash.

In this step, it is detected that a player puts cash in the second area 67 of the game table by image detection. For example, the specific detection method may be based on multiple images sequentially captured in time sequence to get the final result of the detection. That is, it can be determined that an event of “the player puts cash in the second area 67” has occurred when the presence of cash in the second area 67 is detected, in other words, the cash state changes from missing to appearing and at the time around the appearance of cash, the player's hand are also detected (the hand and the cash can be appear in a same image or different images, even in different images, the captured time cannot be far apart). Wherein, detecting the player's hand can comprise that to identify the player's ID by associating the detected hand and player's face.

The game process is in the stage of Player Putting Cash, when “a player putting cash in the second area 67” event is triggered. At this stage, images of the game table captured by a camera can be acquired, and the images can comprise the cash used by the player to exchange the game coins. Through the neural network for image detection, the cash quantity and cash denomination can be acquired, furthering, the value of cash can be acquired. The sequence of image detection to acquire cash information and an event stage is not limited in this embodiment. For example, it is also possible to acquire cash value through image detection first, and then obtain the cash value when the event “a player puts cash in the second area 67” is triggered.

The game information processing device can cache game progress. For example, it can cache current the game process which is the Player Putting Cash stage of the “cash buy in” (may be referred to as the third stage). In addition, some object information acquired at this stage can also be cached. For example, cash quantity, cash denomination, and cash value.

In step 702, in response to detecting that a game master picks up the player's cash, entering the stage of Game Master Putting Cash. Similarly, during the detection of an event on the game table, it can be confirmed that the game steps in the stage of game master putting cash, that is, the game is switched from the third stage Player Putting Cash to the first stage Game Master Putting Cash, when the event of “a game master takes the player's cash” happens, that is, the cash (may be referred to as a second object) state changes from appearing to missing and a game master's hand is also detected.

In step 704, in response to detecting that the game master puts game coins, entering the stage of Game Master Putting Game Coins, and acquiring images involving game coins captured in this stage.

In this step, it can be determined that the game process can step into the stage Game Master Putting Game Coins, when detecting that the game master puts the game coins in the first area 66 by the captured images and the current cached game process is in the first stage Game Master Putting Cash. The stage Game Master Putting Game Coins can be referred to as s second stage, and the current game process can also be changed to the aforementioned stage Game Master Putting Game Coins in the cache.

Acquiring an image set captured in the second stage, and images of the image set involve the game coins. Acquiring an image for which the number of the game coins is largest in the image set.

In this example, the comparison and monitoring of game coins and cash is mainly to make sure whether are equivalent in value that the game coins of the stage Game Master Putting Game Coins and the cash offered by a player. Therefore, by monitoring the switch of game progress, selecting images captured in the stage Game Master Putting Game Coins to be used to detect and acquire game coins information. In this way, it can not only save processing resources, but also further ensure to acquire accurate images used to be detected.

In step 706, detecting the state of the game coins in the image. If the game coins in the image are in the stacked state, determining that the image is a first image, and computing the value of the game coins by detecting the first image.

For example, acquiring an object box by detecting the game coins involved in the first image. determining a physical space parameter of the first object based on respective coordinates of one or more key points on the object box. By combining with the example described in FIG. 5, the value of W can be acquired as the physical space parameter of the game coins. The game coins can be determined to be in the stacked state, if the parameter value is less than or equal to the preset parameter threshold 2.2 cm.

In response to the stacked state of the game coins, a number of game coins and a denomination of game coins are acquired by image detection, and the value of the game coins is computed according to the number and denomination. For example, the value of game coins=the denomination of game coins*the number of game coins. When a pile of game coins includes multiple denominations, the value of each denomination can be determined using the above formula.

In this example, the number of game coins is determined based on the game table image captured by the side-view camera installed by the side of the game table. The number of game coins computed by image detection is more accurate, when the game coins involved in the image are in the stacked state. Therefore, selecting game coins information detected by corresponding to the image involving stacked game coins is helpful to further ensure the accuracy of the calculation of the game coins value.

In step 708, determining an object comparison result by comparing the game coins value with the cash value.

For example, a cash value can be computed according to the cached cash quantity and cash denomination. Then comparing the cash value with the game coins value to make sure whether they are equivalent.

If it is confirmed that they are equivalent, for example, 100 dollars of cash is exchanged for 100 dollars of game coins, it means that the game master counts the game coins correctly, and the game continues to a next stage. If it is confirmed that it is a non-equivalent exchange, then goes to step 710.

In step 710, sending an alert message to GTT.

In this step, an alert message can be sent to the GTT from a game information processing device, which includes object information deviation, and the object information deviation may be, for example, less a few game coins. For example, an alert message “one less game coin” can be displayed on the screen of the GTT on the game table, or the alert can be broadcast by voice. The game master can correct the error in time after receiving the alert.

When in the “Game Master Putting Game Coins” stage, the disappearance of cash is detected in an image, which indicates that the game master has begun to collect the cash, the game can step into the final stage “Game Master Collection Cash”. At this moment, all alerts can be removed, the cache can be cleared, and the progress of “cash buy in” can be initialized. When all these actions have done, the entire process of “cash buy in” is over.

When the method of comparing objects in this embodiment is applied to a game place, game coins information and cash information can be acquired through image detection, which can be compared automatically and accurately, thus improving the efficiency and accuracy of game coins exchange. And by selecting game coins information of the stack state for comparison, also further to ensure the accuracy of exchange monitoring.

In addition, this method can help a game place complete the automatic counting game coins in the stage of “cash buy in”, which is more accurate than the existing method that relies on the self-consciousness of a game master and the supervision of a pit manager and players. It can also digitize the game master's performance. For example, the error rate of a game master's counting game coins can be calculated and uploaded to the big data system for analysis, so that the game place can realize a digital operation. The game place management can obtain an objective and accurate analysis of the game master's work performance; even the pit manager position of the game place can be removed, which reduces game place operating costs and improves operating efficiency.

FIG. 8 shows a schematic structural diagram of a device of comparing objects provided by at least one embodiment of the present disclosure. As shown in FIG. 8, the device may include an information acquisition module 81 and a comparison processing module 82.

The information acquisition module 81 is configured to acquire first object information and second object information, wherein the first object information is acquired by detecting the first object involved in a first image, and the second object information is acquired by detecting the second object involved in a second image, and the second object is used to exchange for the first object.

The comparison processing module 82 is configured to determine an object comparison result based on the first object information and the second object information, where the object comparison result indicates whether the first object and the second object are equivalent in value.

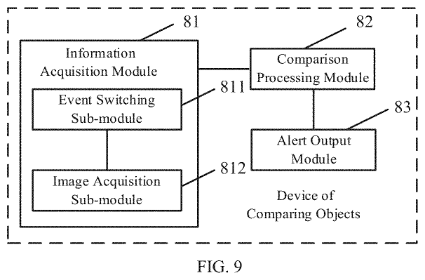

In an example, as shown in FIG. 9, the information acquisition module 81 may include:

The event switching sub-module 811, which may switch the event process from a first stage to a second stage in response to detecting that the first object appears in a first area of an image for an event progress and the event progress is in a first stage currently.

The image acquisition sub-module 812, which may acquire the first image captured in the second stage.

In an example, the event switching submodule 811, which may further switch the event progress from a third stage to a first stage in response to detecting that the second object in a second area in an image for the event progress and the current event progress is in the third stage.

The image acquisition sub-module 812, which may further acquire the second image captured in the first stage.

In an example, when the information acquisition module 81 is used to acquire first object information, acts include: detecting a first object state related to the first object involved in the first image; acquiring the first object information by detecting the first object involved in the first image in response to that the first object state is a default state.

In an example, as shown in FIG. 9, the device may further include: an alert output module 83.

The alert output module 83 may output exchange alarm information in response to the object comparison result indicating that the first object and the second object are non-equivalent in value.

In some embodiments, the above-mentioned apparatus may be used to execute any corresponding method described above, and for the sake of brevity, it will not be repeated herein.

An electronic device also be provided in an embodiment of the present disclosure, the device includes a memory and a processor, the memory is used to store computer-readable instructions, and the processor is used to call the computer instructions to implement the method according to any one of the foregoing embodiments of the present disclosure

The embodiments of the present disclosure also provide a computer-readable storage medium, having a computer program stored thereon, where when the program is executed by a processor, the method according to any one of the foregoing embodiments of the present disclosure is implemented.

The embodiments of the present disclosure also provide a computer program product, having a computer program stored thereon, where when the computer program is executed by a processor, the driving state detection method according to any one of the foregoing embodiments of the present disclosure is implemented.

Among them, “and/or” in the embodiments of the present disclosure means having at least one of the two, for example, “A and/or B” includes three schemes: A, B, and “A and B”.

The various embodiments in the present disclosure are described progressively, and the same or similar parts among the various embodiments can be referred to each other, and each embodiment focuses on the differences from other embodiments. As for the data processing device embodiment, since it substantially corresponds to the method embodiment, the description thereof is relatively simple, and relevant parts can be referred to the description of the method embodiment.

These specific embodiments are described above in the present disclosure. Other embodiments are within the scope of the appended claims. In some cases, the acts or steps described in the claims can be performed in a different order than in the embodiments and still achieve desired results. In addition, the processes depicted in the drawings do not necessarily require a particular order or sequential order to be shown to achieve the desired results. In some embodiments, multitasking and parallel processing are also possible or may be advantageous.

The embodiments of the subject and functional operations described in the present disclosure can be implemented in the following: digital electronic circuits, tangible computer software or firmware, computer hardware including the structures disclosed in the present disclosure and their structural equivalents, or a combination thereof. Embodiments of the subject matter described in the present disclosure may be implemented as one or more computer programs, that is, one or more modules in the instructions of a computer program encoded on a tangible non-transitory program carrier to be performed by the data processing device or control the operations of the data processing device. Alternatively or additionally, the program instructions may be encoded on artificially generated propagated signals, such as machine-generated electrical, optical, or electromagnetic signals, which are generated to encode information and transmit it to a suitable receiver device for execution by a data processing device. The computer storage medium may be a machine-readable storage device, a machine-readable storage substrate, a random or serial access memory device, or a combination thereof.

The processing and logic flow described in the present disclosure may be executed by one or more programmable computers executing one or more computer programs to perform corresponding functions by operating on input data and generating outputs. The processing and logic flow can also be executed by a specialty logic gate, such as FPGA (Field Programmable Gate Array) or ASIC (Application Specific Integrated Circuit), and the device can also be implemented as a specialty logic gate.

Computers suitable for executing computer programs include, for example, general-purpose and/or special-purpose microprocessors, or any other type of central processing unit. Generally, the central processing unit will receive instructions and data from a read-only memory and/or a random access memory. The basic components of a computer include a central processing unit for implementing or executing instructions and one or more memory devices for storing instructions and data. Generally, a computer will also include one or more mass storage devices for storing data, such as magnetic disks, magneto-optical disks, or CD-ROM, etc., or the computer may be operatively coupled with the mass storage device to receive data from or send data to it, or both. However, the computer does not have to have such equipment. In addition, the computer can be embedded in another device, such as a mobile phone, a personal digital assistant (PDA), a mobile audio or video player, a game console, a global positioning system (GPS) receiver, or, a portable storage device such as a universal serial bus (USB) flash drive, to name just a few.

Computer-readable media suitable for storing computer program instructions and data include all forms of non-volatile memory, media, and memory devices, including, for example, semiconductor memory devices (such as EPROM, EEPROM, and flash memory devices), magnetic disks (such as internal hard disks or removable disks), magneto-optical disks, CD-ROM and DVD-ROM disks. The processor and the memory can be supplemented by or incorporated into a special logic gate.

Although the present disclosure contains implementation in detail, these should not be construed to limit the scope of any disclosure or the scope of protection, but are mainly used to describe the features of specific embodiments of the specific disclosure. Some features described in multiple embodiments within the present disclosure can also be implemented in combination in a single embodiment. On the other hand, various features described in a single embodiment can also be implemented in multiple embodiments separately or in any suitable sub-combination. In addition, although features may function in some combinations as described above and even initially require protection, one or more features from the claimed combination may be removed in some cases from the combination, and the claimed combination of protection may point to a sub-combination or a variation of the sub-combination.

Similarly, although acts are depicted in a specific order in the drawings, this should not be construed as requiring the acts to be performed in the specific order shown or sequentially, or requiring all illustrated operations to be performed to achieve the desired result. In some cases, multitasking and parallel processing may be advantageous. In addition, the separation of various system modules and components in the above embodiments should not be understood to mean that such separation is required in all embodiments, and it should be understood that the described program components and systems can usually be integrated together in a single software product or packaged into multiple software products.

Thus, specific embodiments of the subject matter have been described. Other embodiments are within the scope of the appended claims. In some cases, the acts recited in the claims can be performed in a different order and still achieve desired results. In addition, the processes depicted in the drawings are not necessarily in the specific order or sequential order shown to achieve the desired result. In some implementations, multitasking and parallel processing may be advantageous.

The foregoing descriptions are only preferred embodiments of one or more embodiments of the present disclosure, and are not intended to limit one or more embodiments of the present disclosure. Any modifications, equivalent substitutions, improvements, etc. made within the spirit and principles of one or more embodiments of this disclosure should be covered by the protection of one or more embodiments of this disclosure.

1. A method of comparing objects, comprising:
acquiring first object information and second object information, wherein,
the first object information is acquired by detecting a first object involved in a first image,
the second object information is acquired by detecting a second object involved in a second image,
the second object is to be exchanged for the first object;
determining an object comparison result according to the first object information and the second object information, wherein the object comparison result indicates whether the first object and the second object are equivalent in value.

2. The method of claim 1, wherein the first object information comprises a first object attribute and a first object quantity related to the first object; the second object information comprises a second object attribute and a second object quantity related to the second object; determining an object comparison result according to the first object information and the second object information, comprises:
determining a first object value according to the first object attribute and the first object quantity;
determining a second object value according to the second object attribute and the second object quantity;
determining whether the first object value and the second object value are equivalent.

3. The method of claim 1, wherein
the first object comprises one or more game coins; and
the second object comprises cash to be exchanged for the one or more game coins by a player.

4. The method of claim 1, wherein, before acquiring the first object information, the method further comprises:
in response to detecting that the first object appears in a first area of an image for an event progress and the event progress is in a first stage currently, switching the event progress from the first stage to a second stage;
acquiring the first image captured in the second stage.

5. The method of claim 4, wherein, acquiring the first image captured in the second stage comprises:
acquiring an image set captured in the second stage, where each of images in the image set involves the first object;
for each of the images in the image set, detecting a first object quantity related to the first object involved in the image;
determining an image for which the first object quantity is largest in the image set as the first image.

6. The method of claim 4, wherein, before acquiring the first image captured in the second stage, the method further comprises:
in response to detecting that the second object appears in a second area of an image for the event progress and the event progress is in a third stage currently, switching the event progress from the third stage to the first stage;
acquiring the second image captured in the first stage.

7. The method of claim 4, wherein, after switching the event progress from the first stage to the second stage, the method further comprises:
in response to detecting that the second object is disappeared from a second area in an image for the event progress and the event process is in the second stage currently, performing at least one of:
cancelling an exchange alert message, wherein the exchange alert message is used to prompt that the first object and the second object are non-equivalent in value; or
clearing event cache information, wherein the event cache information comprises at least one of event progress, object information, and object value.

8. The method of claim 1, wherein, acquiring the first object information comprises:
detecting a first object state related to the first object involved in the first image;
in response to that the first object state is a default state, acquiring the first object information by detecting the first object involved in the first image.

9. The method of claim 8, wherein detecting the first object state related to the first object involved in the first image comprises:
acquiring an object box by detecting the first object involved in the first image;
determining a physical space parameter of the first object based on respective coordinates of one or more key points on the object box;
determining the first object state by comparing the physical space parameter with a preset parameter threshold.

10. The method of claim 8, wherein
the first object comprises one or more game coins;
the first object information indicates a total value of the one or more game coins calculated according to a quantity and a denomination of each kind of game coins in the one or more game coins;
in response to that the first object state is a default state, acquiring the first object information by detecting the first object involved in the first image, comprises:
in response to detecting that the one or more game coins are stacked, acquiring the total value of the one or more game coins by detecting respective game coins involved in the first image.

11. The method of claim 1, further comprises:
in response to the object comparison result indicating that the first object and the second object are non-equivalent in value, outputting an exchange alert message.

12. The method of claim 11, wherein in response to the object comparison result indicating that the first object and the second object are non-equivalent in value, outputting the exchange alert message, comprises:
in response to the object comparison result indicating that the first object and the second object are non-equivalent in value, determining an object information deviation according to the first object information and the second object information;
outputting the exchange alert message which comprises the object information deviation.

13. An electronic device, comprising: a memory and a processor, the memory is used to store computer-readable instructions, and the processor is used to invoke the computer instructions to perform operations for comparing objects, the operations comprising:
acquiring first object information and second object information, wherein,
the first object information is acquired by detecting a first object involved in a first image,
the second object information is acquired by detecting a second object involved in a second image,
the second object is to be exchanged for the first object;
determining an object comparison result according to the first object information and the second object information, wherein the object comparison result indicates whether the first object and the second object are equivalent in value.

14. A computer-readable storage medium, having a computer program stored thereon, wherein in a case that the computer program is executed by a processor to perform operations for comparing objects, the operations comprising:
acquiring first object information and second object information, wherein,
the first object information is acquired by detecting a first object involved in a first image,
the second object information is acquired by detecting a second object involved in a second image,
the second object is to be exchanged for the first object;
determining an object comparison result according to the first object information and the second object information, wherein the object comparison result indicates whether the first object and the second object are equivalent in value.
